(19) United States
(12) Patent Application Publication
(10) Pub. No.: US 2014/0078249 A1
(43) Pub. Date: Mar. 20, 2014

(54) INDICATION OF FRAME-PACKED STEREOSCOPIC 3D VIDEO DATA FOR VIDEO CODING

(71) Applicant: QUALCOMM Incorporated, San Diego, CA (US)

(72) Inventor: Ye-Kui Wang, San Diego, CA (US)

(73) Assignee: QUALCOMM Incorporated, San Diego, CA (US)

(21) Appl. No.: 14/029,120

(22) Filed: Sep. 17, 2013

Related U.S. Application Data
(60) Provisional application No. 61/703,662, filed on Sep. 20, 2012.
(60) Provisional application No. 61/706,647, filed on Sep. 27, 2012.

(51) Int. Cl. H04N 13/00

(52) U.S. Cl. CPC H04N 13/0048
USPC 348/43

(57) ABSTRACT

This disclosure describes techniques for signaling and using an indication that video data is in a frame-packed stereoscopic 3D video data format. In one example of the disclosure, a method for decoding video data comprises receiving video data, receiving an indication that indicates whether any pictures in the received video data contain frame-packed stereoscopic 3D video data, and decoding the received video data in accordance with the received indication. The received video data may be rejected if the video decoder is unable to decode frame-packed stereoscopic 3D video data.

This application claims the benefit of U.S. Provisional Application No. 61/703,662, filed on Sep. 20, 2012, and U.S. Provisional Application No. 61/706,647, filed on Sep. 27, 2012, the entire content of both of which is incorporated herein by reference.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for signaling and using an indication that video data is in a frame-packed stereoscopic 3D video data format.

In one example of the disclosure, a method for decoding video data comprises receiving video data, receiving an indication that indicates whether any pictures in the received video data contain frame-packed stereoscopic 3D video data, and decoding the received video data in accordance with the received indication.

In another example of the disclosure, a method for encoding video data comprises encoding video data, generating an indication that indicates whether any pictures in the encoded video data contain frame-packed stereoscopic 3D video data, and signaling the indication in an encoded video bitstream.

In another example of the disclosure, an apparatus configured to decode video data comprises a video decoder configured to receive video data, receive an indication that indicates whether any pictures in the received video data contain frame-packed stereoscopic 3D video data, and decode the received video data in accordance with the received indication.

In another example of the disclosure, an apparatus configured to encode video data comprises a video encoder configured to encode video data, generate an indication that indicates whether any pictures in the encoded video data contain frame-packed stereoscopic 3D video data, and signal the indication in an encoded video bitstream.

In another example of the disclosure, an apparatus configured to decode video data comprises means for receiving video data, means for receiving an indication that indicates whether any pictures in the received video data contain frame-packed stereoscopic 3D video data, and means for decoding the received video data in accordance with the received indication.

In another example of the disclosure, an apparatus configured to encode video data comprises means for encoding video data, means for generating an indication that indicates whether any pictures in the encoded video data contain frame-packed stereoscopic 3D video data, and means for signaling the indication in an encoded video bitstream.

In another example, this disclosure describes a computer-readable storage medium storing instructions that, when executed, cause one or more processors of a device configured to decode video data to receive video data, receive an indication that indicates whether any pictures in the received video data contain frame-packed stereoscopic 3D video data, and decode the received video data in accordance with the received indication.

In another example, this disclosure describes a computer-readable storage medium storing instructions that, when executed, cause one or more processors of a device configured to encode video data to encode video data, generate an indication that indicates whether any pictures in the encoded video data contain frame-packed stereoscopic 3D video data, and signal the indication in an encoded video bitstream.

The techniques of this disclosure are also described in terms of apparatuses configured to execute the techniques, as well as computer-readable storage medium storing instructions that cause one more processors to perform the techniques.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize the techniques described in this disclosure.

FIG. 2 is a conceptual diagram showing an example process for frame-compatible stereoscopic video coding using a side-by-side frame packing arrangement.

FIG. 3 is a block diagram illustrating an example video encoder that may implement the techniques described in this disclosure.

FIG. 4 is a block diagram illustrating an example video decoder that may implement the techniques described in this disclosure.

FIG. 5 is a flowchart illustrating an example video encoding method according to one example of the disclosure.

FIG. 6 is a flowchart illustrating an example video decoding method according to one example of the disclosure.

### DETAILED DESCRIPTION

This disclosure describes techniques for signaling and using an indication that indicates that video data is coded in a frame-packed arrangement (e.g., as frame-packed stereoscopic three-dimensional (3D) video data). A bitstream coded according to the high efficiency video coding (HEVC) may include frame packing arrangement (FPA) supplemental enhancement information (SEI) messages that may include information that indicates whether or not the video is in a frame-packed arrangement.

However, support of decoding frame-packed video, through the FPA SEI messages, exhibits several drawbacks. For one, a backward compatibility issue may exist. That is, some decoders do not recognize or are not configured to decode FPA SEI messages, and thus would ignore an indication of frame-packed video and would output the decoded pictures as if the video was not in frame-packed stereoscopic 3D format. Consequently, the resulting video quality can be seriously distorted, generating a poor user experience.

As another drawback, even for decoders configured to decode FPA SEI messages, some conforming decoders may be implemented in way to ignore all SEI messages or only to handle a subset of them. For example, some decoders may be configured to only handle buffering period SEI messages and picture timing SEI messages, and ignore other SEI messages. Such decoders would also ignore the FPA SEI messages in a bitstream, and the same seriously distorted video quality can happen.

Furthermore, many video clients or players (i.e., any device or software configured to decode video data) are not configured to decode frame-packed stereoscopic 3D video data. Because SEI messages, including FPA SEI messages, are not required to be recognized or processed by conforming decoders, a client or player with a conforming HEVC decoder that does not recognize FPA SEI messages would ignore the FPA SEI messages in such a bitstream and decode and output the decoded pictures as if the bitstreams only contained pictures that are not frame-packed stereoscopic 3D video data. Consequently, the resulting video quality can be sub-optimal. Furthermore, even for a client or a player with conforming HEVC decoder that does recognize and is able to process FPA SEI messages, all access units must be inspected to check the absence of FPA SEI messages, and all the present FPA SEI messages have to be parsed and interpreted before a conclusion can be drawn that all pictures are frame-packed stereoscopic 3D video data or not.

In view of these drawbacks, and as will be described in more detail below, various examples of the disclosure propose signaling an indication of whether a coded video sequence contains frame-packed pictures using one bit in the profile, tier and level syntax.

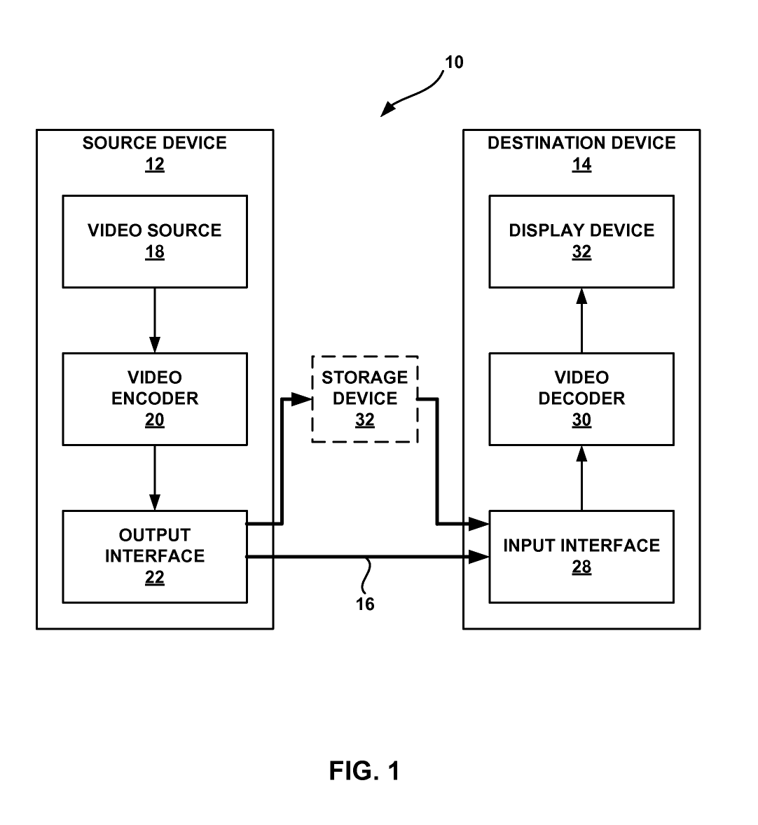

FIG. 1 is a block diagram illustrating an example video encoding and decoding system 10 that may utilize the techniques described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 32. Similarly, encoded data may be accessed from storage device 32 by input interface. Storage device 32 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 32 may correspond to a file server or another intermediate storage device that may hold the encoded video generated by source device 12. Destination device 14 may access stored video data from storage device 32 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 32 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 32 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 32, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development by the Joint Collaboration Team on Video Coding (JCT-VC) of ITU-T Video Coding Experts Group (VCEG) and ISO/IEC Motion Picture Experts Group (MPEG). One Working Draft (WD) of HEVC, and referred to as HEVC WD8 hereinafter, is available from http://phenix.int-evry.fr/jct/doc_end_user/documents/10_Stockholm/wg11/JCTVC-J1003-v8.zip.

A recent draft of the HEVC standard, referred to as “HEVC Working Draft 10” or “WD10,” is described in document JCTVC-L1003v34, Bross et al., “High efficiency video coding (HEVC) text specification draft 10 (for FDIS & Last Call),” Joint Collaborative Team on Video Coding (JCT-VC) of ITU-T SG16 WP3 and ISO/IEC JTC1/SC29/WG11, 12th Meeting: Geneva, CH, 14-23 Jan., 2013, which, as of Jun. 6, 2013, is downloadable from: http://phenix.int-evry.fr/jct/doc_end_user/documents/12_Geneva/wg11/JCTVC-L1003-v34.zip.

Another draft of the HEVC standard, is referred to herein as “WD10 revisions” described in Bross et al., “Editors' proposed corrections to HEVC version 1,” Joint Collaborative Team on Video Coding (JCT-VC) of ITU-T SG16 WP3 and ISO/IEC JTC1/SC29/WG11, 13^{th} Meeting, Incheon, KR, April 2013, which as of Jun. 7, 2013, is available from: http://phenix.int-evey.fr/jct/doc_end_user/documents/13_Incheon/wg11/JCTVC-M0432-v3.zip

Video encoder 20 and video decoder 30 are described in this disclosure, for purposes of illustration, as being configured to operate according to one or more video coding standards. However, the techniques of this disclosure are not necessarily limited to any particular coding standard, and may be applied for a variety of different coding standards. Examples of other proprietary or industry standards include the ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions, or extensions of, modifications of, or additions to, such standards.

Video encoder 20 and video decoder 30 may also be configured to store video data in a certain file format, or transmit data according to real-time transport protocol (RTP) formats or through multimedia services.

File format standards include ISO base media file format (ISOBMFF, ISO/IEC 14496-12) and other file formats derived from the ISOBMFF, including MPEG-4 file format (ISO/IEC 14496-14), 3GPP file format (3GPP TS 26.244) and advanced video coding (AVC) file format (ISO/IEC 14496-15). Currently, an amendment to AVC file format for storage of HEVC video content is being developed by MPEG. This AVC file format amendment is also referred to as HEVC file format.

RTP payload formats include H.264 payload format in RFC 6184, “RTP Payload Format for H.264 Video”, scalable video coding (SVC) payload format in RFC 6190, “RTP Payload Format for Scalable Video Coding”, and many others. Currently, the HEVC RTP payload format is being developed by the Internet Engineering Task Force (IETF). RFC 6184 is available, as of Jul. 26, 2013, from http://tools.ietf.org/html/rfc6184, the entire content of which is incorporated by reference herein. RFC 6190 is available, as of Jul. 26, 2013, from http://tools.ietf.org/html/rfc6190, the entire content of which is incorporated by reference herein.

3GPP multimedia services include 3GPP dynamic adaptive streaming over HTTP (3GP-DASH, 3GPP TS 26.247), packet-switched streaming (PSS, 3GPP TS 26.234), multimedia broadcast and multicast service (MBMS, 3GPP TS 26.346) and multimedia telephone service over IMS (MTSI, 3GPP TS 26.114).

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC has developed the HEVC standard. The HEVC standardization efforts were based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into coding units (CUs) according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split, and may also define a minimum size of the coding nodes.

A CU includes a coding node and prediction units (PUs) and transform units (TUs) associated with the coding node. A size of the CU generally corresponds to a size of the coding node and must typically be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

In general, a TU is used for the transform and quantization processes. A given CU having one or more PUs may also include one or more transform units (TUs). Following prediction, video encoder 20 may calculate residual values from the video block identified by the coding node in accordance with the PU. The coding node is then updated to reference the residual values rather than the original video block. The residual values comprise pixel difference values that may be transformed into transform coefficients, quantized, and scanned using the transforms and other transform information specified in the TUs to produce serialized transform coefficients for entropy coding. The coding node may once again be updated to refer to these serialized transform coefficients. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data to which the transforms specified by TUs of the CU are applied. The residual data may correspond to pixel differences between pixels of the unencoded picture and prediction values corresponding to the CUs. Video encoder 20 may form the residual data for the CU, and then transform the residual data to produce transform coefficients.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

For stereoscopic 3D video, a frame of video coded according to HEVC may include a half resolution version of both a right image and a left image. Such a coding format is sometimes called frame-packed stereoscopic 3D video. To produce a 3D effect in video, two views of a scene, e.g., a left eye view and a right eye view, may be shown simultaneously or nearly simultaneously. Two pictures of the same scene, corresponding to the left eye view and the right eye view of the scene, may be captured from slightly different horizontal positions, representing the horizontal disparity between a viewer's left and right eyes. By displaying these two pictures simultaneously or nearly simultaneously, such that the left eye view picture is perceived by the viewer's left eye and the right eye view picture is perceived by the viewer's right eye, the viewer may experience a three-dimensional video effect.

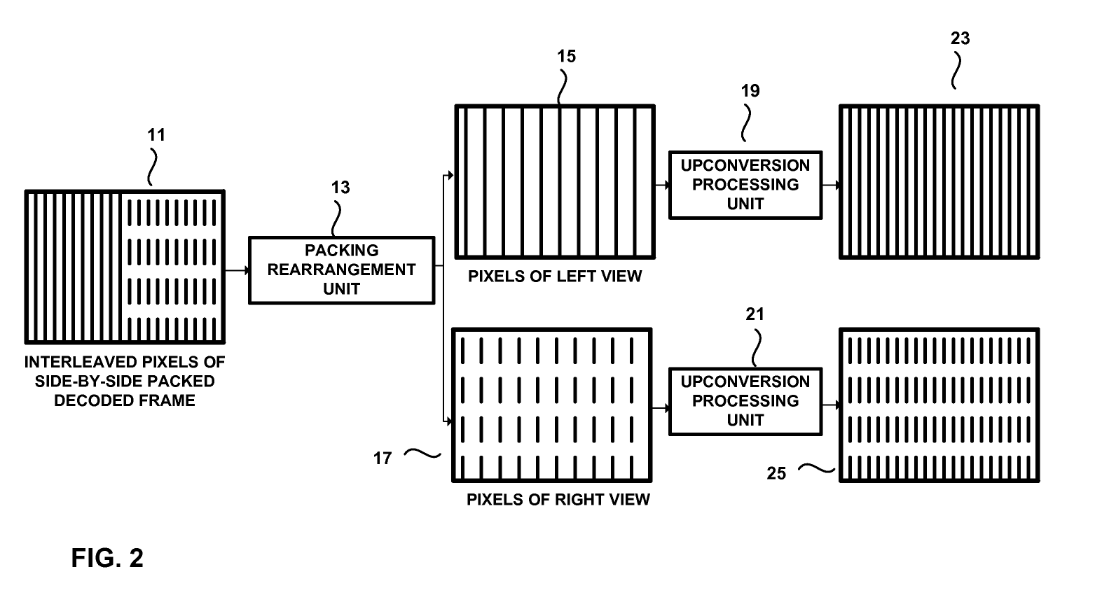

FIG. 2 is a conceptual diagram showing an example process for frame-compatible stereoscopic video coding using a side-by-side frame packing arrangement. In particular, FIG. 2 shows the process for rearranging pixels for a decoded frame of frame-compatible stereoscopic video data. The decoded frame 11 consists of interleaved pixels that are packed in a side-by-side arrangement. A side-by-side arrangement consists of pixels for each view (in this example a left view and a right view) being arranged in columns. As one alternative, a top-down packing arrangement would arrange pixels for each view in rows. The decoded frame 11 depicts pixels of the left view as solid lines and the pixels of the right view as dashed lines. The decoded frame 11 may also be referred to as an interleaved frame, in that decoded frame 11 includes side-by-side interleaved pixels.

The packing rearrangement unit 13 splits the pixels in the decoded frame 11 into a left view frame 15 and a right view frame 17 according to the packing arrangement signaled by an encoder, such as in an FPA SEI message. As can be seen, each of the left and right view frames are at half resolution as they contain only every other column of pixels for the size of the frame.

The left view frame 15 and the right view frame 17 are then upconverted by the upconversion processing units 19 and 21, respectively, to produce an upconverted left view frame 23 and an upconverted right view frame 25. The upconverted left view frame 23 and the upconverted right view frame 25 may then be displayed by a stereoscopic display.

Previous proposals for HEVC include the specification of a frame packing arrangement (FPA) SEI message to indicate that the video data is frame-packed stereoscopic 3D video. However, there are drawbacks with existing methods for indication of HEVC-based frame-packed stereoscopic video data with an SEI message.

One drawback is associated with the indication of HEVC-based frame-packed stereoscopic 3D video in an HEVC bitstream. An HEVC bitstream may contain frame-packed stereoscopic 3D video, as indicated by FPA SEI messages in the bitstream. Since SEI messages are not required to be recognized or processed by conforming HEVC decoders, a conforming HEVC decoder that does not recognize FPA SEI messages would ignore such messages and decode and output the decoded frame-packed stereoscopic 3D pictures as if the video was not frame-packed stereoscopic 3D video. Consequently, the resulting video quality can be seriously distorted, generating a very poor user experience.

Other drawbacks relate to indicating the presence of frame-packed stereoscopic 3D video data in file formats, RTP payloads, and multimedia services. As one example, proposals for the HEVC file format lack mechanisms to indicate HEVC-based frame-packed stereoscopic video. With some proposed designs of HEVC RTP payload format and some proposed designs of HEVC itself, an RTP sender and an RTP receiver implementing both HEVC and HEVC RTP payload format would not be able to negotiate on the use of HEVC-based frame-packed stereoscopic 3D video, and the communication may occur with the two sides having different assumptions.

For example, the sender may send an HEVC-based frame-packed stereoscopic 3D video, while the receiver accepts it and renders the video as if the bitstreams were not a frame-packed stereoscopic 3D video. For streaming or multicast applications, wherein a client decides whether to accept a content or join a multicast session based on session description protocol (SDP), that includes a description of the content, clients not equipped with proper handling (e.g., de-packing) of a frame-packed stereoscopic 3D video may mistakenly accept the content and play a frame-packed stereoscopic 3D video as if it was not a frame-packed stereoscopic 3D video.

In view of these drawbacks, the present disclosure presents techniques for improved signaling of an indication of whether or not video data includes frame-packed stereoscopic 3D video data. The techniques of this disclosure allow HEVC-conforming decoders to determine whether received video contained in a bitstream is frame-packed stereoscopic 3D video without the need to be able to recognize FPA SEI messages. In one example of the disclosure, this is accomplished by including an indication in the bitstream, e.g., as a flag (frame-packed flag) that is not located in an SEI message. The flag equal to 0 indicates that there is no FPA SEI message and the video data is not in a frame-packed stereoscopic 3D format. The flag equal to 1 indicates that there is (or alternatively, may be) an FPA SEI message and that the video in the bitstream is (or alternatively, may be) frame-packed stereoscopic 3D video.

Upon determining that the video is (or alternatively, may be) frame-packed stereoscopic 3D video, video decoder 30 may reject the video to avoid a bad user experience. For example, video decoder 30 may reject video data indicated as include frame-packed stereoscopic 3D video data if it is unable to decode data configured in such an arrangement. The indication of frame-packed stereoscopic 3D video data may be included in either the video parameter set (VPS) or the sequence parameter set (SPS), or both.

Profile and level information (including the tier information) included in the VPS and/or SPS can be directly included in a higher system levels, e.g., in a sample description of an HEVC track in an ISO based media file format file (e.g., file format information), in a session description protocol (SDP) file, or in a media presentation description (MPD). Based on the profile and level information, the client (e.g., video streaming client or video telephony client) may determine to accept or choose contents or formats to consume. As such, according to one example of the disclosure, the indication for frame-packed stereoscopic 3D video may be included as part of the profile and level information, e.g., by using one bit in the general_reserved_zero 16 bits field and/or the sub_layer_reserved_zero_{—}16 bits field[i], as specified in HEVC WD8, to represent the above-mentioned flag.

For example, if video decoder 30 receives a bit in the profile and/or level information that indicates that the video is encoded in a frame-packed stereoscopic 3D arrangement, and video decoder 30 is not configured to decode such video data, video decoder 30 may reject the video data (i.e., not decode it). If video decoder 30 is configured to decode frame-packed stereoscopic 3D video data, decoding may proceed. Likewise, if video decoder 30 receives a bit in the profile and/or level information that indicates that the video is not encoded in a frame-packed stereoscopic 3D arrangement, video decoder 30 may accept the video data and proceed with decoding.

Profiles and levels specify restrictions on bitstreams and hence limits on the capabilities needed to decode the bitstreams. Profiles and levels may also be used to indicate interoperability points between individual decoder implementations. Each profile specifies a subset of algorithmic features and limits that shall be supported by all decoders conforming to that profile. Each level specifies a set of limits on the values that may be taken by the syntax elements of a video compression standard. The same set of level definitions is used with all profiles, but individual implementations may support a different level for each supported profile. For any given profile, levels generally correspond to decoder processing load and memory capability.

As opposed to FPA SEI messages, HEVC-compatible decoders are required to be able to interpret syntax elements in the VPS and SPS. As such, any indication of frame-packed stereoscopic 3D video (or indication that an FPA SEI message exists) included in the VPS or SPS will be parsed and decoded. Furthermore, since the VPS or SPS apply to more than one access unit, not every access unit must be checked for an indication of frame-packed stereoscopic 3D video, as in the case with FPA SEI messages.

The following section describes techniques for indicating frame-packed stereoscopic 3D video in an RTP payload. An optional payload format parameter, e.g., named frame-packed, may be specified as follows. The frame-packed parameter signals the properties of a stream or the capabilities of a receiver implementation. The value may be equal to either 0 or 1. When the parameter is not present, the value may be inferred to be equal to 0.

When the parameter is used to indicate the properties of a stream, the following applies. The value 0 indicates that the video represented in the stream is not a frame-packed video, and that, in the stream, there is no FPA SEI message. The value 1 indicates that the video represented in the stream may be a frame-packed video, and that, in the stream, there may be FPA SEI messages. Of course, the semantics of values 0 and 1 may be reversed.

When the parameter is used for capability exchange or session setup, the following applies. The value 0 indicates that the entity (i.e., video decoder and/or client) supports, for both receiving and sending, only streams for which the represented video is not frame-packed, and that there is no PFA SEI message. The value 1 indicates that the entity supports, for both receiving and sending, streams for which the represented video is frame-packed, and that there may be FPA SEI messages.

The optional parameter frame-packed, when present, may be included in the “a=fmtp” line of an SDP file. The parameter is expressed as a media type string, in the form of frame-packed=0 or frame-packed=1.

When an HEVC stream is offered over RTP using an SDP file in an Offer/Answer model for negotiation, the frame-packed parameter is one of the parameters identifying a media format configuration for HEVC, and may be used symmetrically. That is, the answerer may either maintain the parameter with the value in the offer or remove the media format (payload type) completely.

When HEVC over RTP is offered with SDP in a declarative style, as in real-time streaming protocol (RTSP) or session announcement protocol (SAP), the frame-packed parameter is used to indicate only stream properties, not the capabilities for receiving streams. In another example, a similar signaling may be specified in the SDP file in general, not specific to HEVC, such that it generically applies to video codecs.

In another example of the disclosure, the frame-packed parameter may have more values, e.g., 0 indicates that the video is not frame-packed and the stream has no FPA SEI message, and a value greater than 0 indicates the video is frame-packed and the frame packing type is indicated by the value of the parameter. In another example, the parameter may contain multiple comma-separated greater-than-0 values, each value indicating a particular frame packing type.

The following shows the syntax and semantics of indicating frame-packed stereoscopic 3D video data in profile, tier, and level syntax according to the techniques of this disclosure. The syntax and semantics of the profile, tier and level are proposed to be signaled as follows.

| profile_tier_level( ProfilePresentFlag, | |
|---|---|
| MaxNumSubLayersMinus1 ) { | Descriptor |
| if( ProfilePresentFlag ) { | |
| general_profile_space | u(2) |
| general_tier_flag | u(1) |
| general_profile_idc | u(5) |
| for( i = 0; i < 32; i++ ) | |
| general_profile_compatibility_flag[ i ] | u(1) |
| general_progressive_frames_only_flag | u(1) |
| general_non_packed_only_flag | u(1) |
| general_reserved_zero_14bits | u(14) |
| } | |
| general_level_idc | u(8) |
| for( i = 0; i < MaxNumSubLayersMinus1; i++ ) { | |
| sub_layer_profile_present_flag[ i ] | u(1) |
| sub_layer_level_present_flag[ i ] | u(1) |
| if( ProfilePresentFlag && | |
| sub_layer_profile_present_flag[ i ] ) { | |
| sub_layer_profile_space[ i ] | u(2) |
| sub_layer_tier_flag[ i ] | u(1) |
| sub_layer_profile_idc[ i ] | u(5) |
| for( j = 0; j < 32; j++ ) | |
| sub_layer_profile_compatibility_flag[ i ][ j ] | u(1) |
| sub_layer_progressive_frames_only_flag[ i ] | u(1) |
| sub_layer_non_packed_only_flag[ i ] | u(1) |
| sub_layer_reserved_zero_14bits[ i ] | u(14) |
| } | |
| if( sub_layer_level_present_flag[ i ] ) | |
| sub_layer_level_idc[ i ] | u(8) |
| } | |
| } | |

The syntax element general_non_packed_only_flag (i.e., the frame-packed indication) equal to 1 indicates that there is no frame packing arrangement SEI message in the coded video sequence. The syntax element general_non_packed_only_flag equal to 0 indicates that there is at least one FPA SEI message in the coded video sequence.

The syntax element general_reserved_zero_{—}14 bits shall be equal to 0 in bitstreams conforming to this specification. Other values for general_reserved_zero_{—}14 bits are reserved for future use by ITU-T|ISO/IEC. Decoders shall ignore the value of general_reserved_zero_{—}14 bits.

The syntax element sub_layer_profile_space[i], sub_layer_tier_flag[i], sub_layer_profile_idc[i], sub_layer_profile_compatibility_flag[i][j], sub_layer_progressive_frames_only_flag[i], sub_layer_non_packed_only_flag[i], sub_layer_reserved_zero_{—}14 bits[i], and sub_layer_level_idc[i] have the same semantics as general_profile_space, general_tier_flag, general_profile_idc, general_profile_compatibility_flag[j], general_progressive_frames_only_flag, general_non_packed_only_flag, general_reserved_zero_{—}14 bits, and general_level_idc, respectively, but apply to the representation of the sub-layer with TemporalId equal to i. When not present, the value of sub_layer_tier_flag[i] is inferred to be equal to 0.

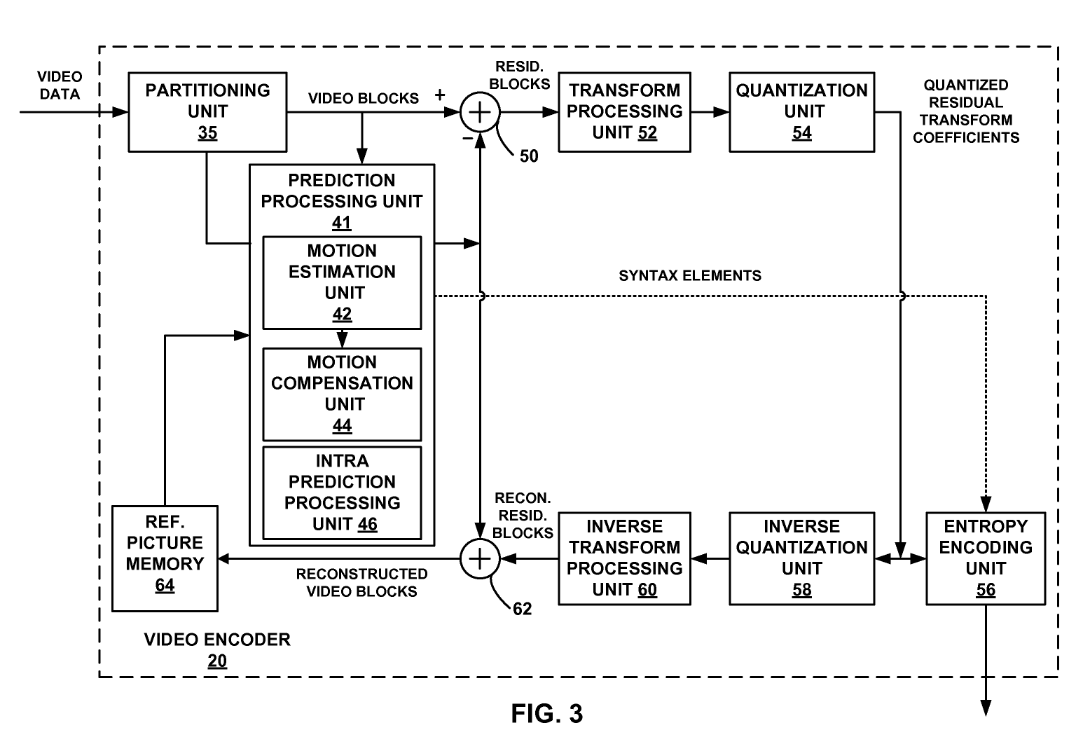

FIG. 3 is a block diagram illustrating an example video encoder 20 that may implement the techniques described in this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 3, video encoder 20 includes a partitioning unit 35, prediction processing unit 41, reference picture memory 64, summer 50, transform processing unit 52, quantization unit 54, and entropy encoding unit 56. Prediction processing unit 41 includes motion estimation unit 42, motion compensation unit 44, and intra prediction processing unit 46. For video block reconstruction, video encoder 20 also includes inverse quantization unit 58, inverse transform processing unit 60, and summer 62. A deblocking filter (not shown in FIG. 3) may also be included to filter block boundaries to remove blockiness artifacts from reconstructed video. If desired, the deblocking filter would typically filter the output of summer 62. Additional loop filters (in loop or post loop) may also be used in addition to the deblocking filter.

As shown in FIG. 3, video encoder 20 receives video data, and partitioning unit 35 partitions the data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra coding modes or one of a plurality of inter coding modes, for the current video block based on error results (e.g., coding rate and the level of distortion). Prediction processing unit 41 may provide the resulting intra- or inter-coded block to summer 50 to generate residual block data and to summer 62 to reconstruct the encoded block for use as a reference picture.

Intra prediction processing unit 46 within prediction processing unit 41 may perform intra-predictive coding of the current video block relative to one or more neighboring blocks in the same frame or slice as the current block to be coded to provide spatial compression. Motion estimation unit 42 and motion compensation unit 44 within prediction processing unit 41 perform inter-predictive coding of the current video block relative to one or more predictive blocks in one or more reference pictures to provide temporal compression.

Motion estimation unit 42 may be configured to determine the inter-prediction mode for a video slice according to a predetermined pattern for a video sequence. The predetermined pattern may designate video slices in the sequence as P slices, B slices or GPB slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation, possibly performing interpolations to sub-pixel precision. Upon receiving the motion vector for the PU of the current video block, motion compensation unit 44 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by video decoder 30 in decoding the video blocks of the video slice.

Intra-prediction processing unit 46 may intra-predict a current block, as an alternative to the inter-prediction performed by motion estimation unit 42 and motion compensation unit 44, as described above. In particular, intra-prediction processing unit 46 may determine an intra-prediction mode to use to encode a current block. In some examples, intra-prediction processing unit 46 may encode a current block using various intra-prediction modes, e.g., during separate encoding passes, and intra-prediction processing unit 46 (or mode select unit 40, in some examples) may select an appropriate intra-prediction mode to use from the tested modes. For example, intra-prediction processing unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction processing unit 46 may calculate ratios from the distortions and rates for the various encoded blocks to determine which intra-prediction mode exhibits the best rate-distortion value for the block.

In any case, after selecting an intra-prediction mode for a block, intra-prediction processing unit 46 may provide information indicative of the selected intra-prediction mode for the block to entropy coding unit 56. Entropy coding unit 56 may encode the information indicating the selected intra-prediction mode in accordance with the techniques of this disclosure. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

After prediction processing unit 41 generates the predictive block for the current video block via either inter-prediction or intra-prediction, video encoder 20 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following the entropy encoding by entropy encoding unit 56, the encoded bitstream may be transmitted to video decoder 30, or archived for later transmission or retrieval by video decoder 30. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within one of the reference picture lists. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reference block for storage in reference picture memory 64. The reference block may be used by motion estimation unit 42 and motion compensation unit 44 as a reference block to inter-predict a block in a subsequent video frame or picture.

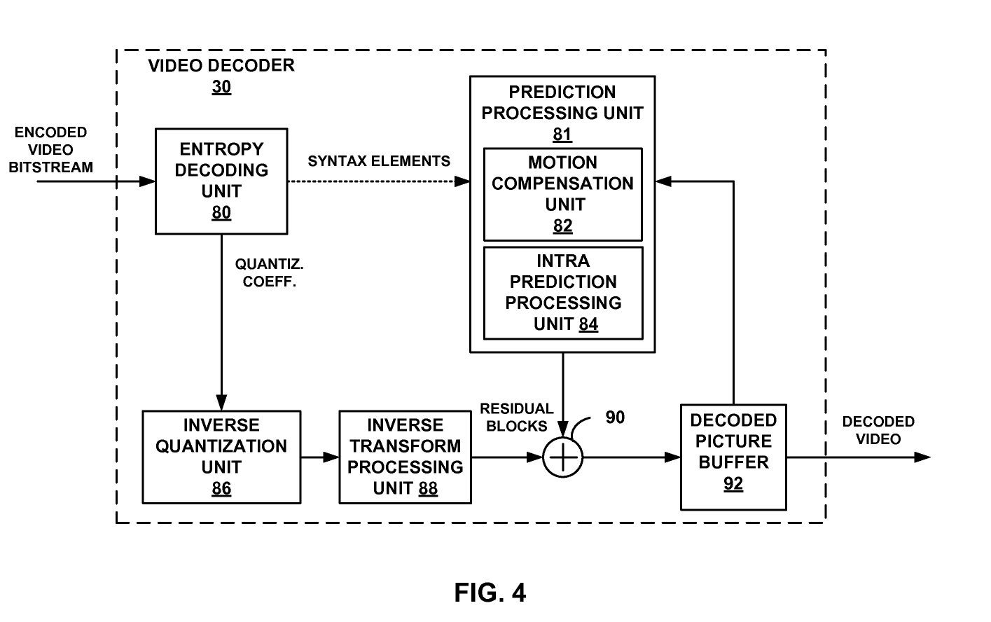

FIG. 4 is a block diagram illustrating an example video decoder 30 that may implement the techniques described in this disclosure. In the example of FIG. 4, video decoder 30 includes an entropy decoding unit 80, prediction processing unit 81, inverse quantization unit 86, inverse transformation unit 88, summer 90, and decoded picture buffer 92. Prediction processing unit 81 includes motion compensation unit 82 and intra prediction processing unit 84. Video decoder 30 may, in some examples, perform a decoding pass generally reciprocal to the encoding pass described with respect to video encoder 20 from FIG. 3.

During the decoding process, video decoder 30 receives an encoded video bitstream that represents video blocks of an encoded video slice and associated syntax elements from video encoder 20. Entropy decoding unit 80 of video decoder 30 entropy decodes the bitstream to generate quantized coefficients, motion vectors, and other syntax elements. Entropy decoding unit 80 forwards the motion vectors and other syntax elements to prediction processing unit 81. Video decoder 30 may receive the syntax elements at the video slice level and/or the video block level.

When the video slice is coded as an intra-coded (I) slice, intra prediction processing unit 84 of prediction processing unit 81 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 82 of prediction processing unit 81 produces predictive blocks for a video block of the current video slice based on the motion vectors and other syntax elements received from entropy decoding unit 80. The predictive blocks may be produced from one of the reference pictures within one of the reference picture lists. Video decoder 30 may construct the reference frame lists, List 0 and List 1, using default construction techniques based on reference pictures stored in decoded picture buffer 92.

Motion compensation unit 82 determines prediction information for a video block of the current video slice by parsing the motion vectors and other syntax elements, and uses the prediction information to produce the predictive blocks for the current video block being decoded. For example, motion compensation unit 82 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by video encoder 20 during encoding of the video blocks to calculate interpolated values for sub-integer pixels of reference blocks. In this case, motion compensation unit 82 may determine the interpolation filters used by video encoder 20 from the received syntax elements and use the interpolation filters to produce predictive blocks.

Inverse quantization unit 86 inverse quantizes, i.e., de-quantizes, the quantized transform coefficients provided in the bitstream and decoded by entropy decoding unit 80. The inverse quantization process may include use of a quantization parameter calculated by video encoder 20 for each video block in the video slice to determine a degree of quantization and, likewise, a degree of inverse quantization that should be applied. Inverse transform processing unit 88 applies an inverse transform, e.g., an inverse DCT, an inverse integer transform, or a conceptually similar inverse transform process, to the transform coefficients in order to produce residual blocks in the pixel domain.

After motion compensation unit 82 generates the predictive block for the current video block based on the motion vectors and other syntax elements, video decoder 30 forms a decoded video block by summing the residual blocks from inverse transform processing unit 88 with the corresponding predictive blocks generated by motion compensation unit 82. Summer 90 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in decoded picture buffer 92, which stores reference pictures used for subsequent motion compensation. Decoded picture buffer 92 also stores decoded video for later presentation on a display device, such as display device 32 of FIG. 1.

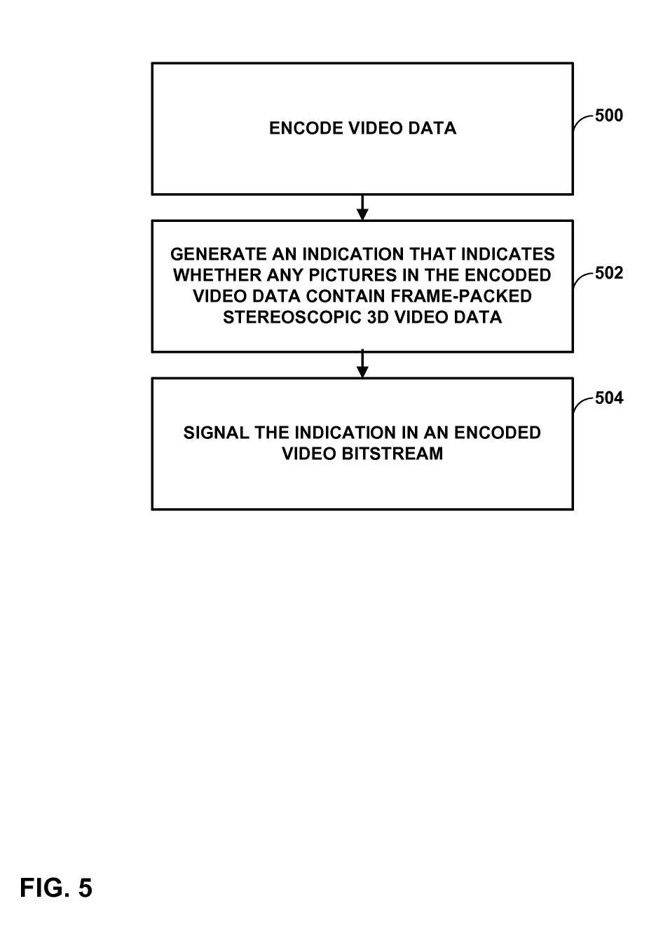

FIG. 5 is a flowchart illustrating an example video encoding method according to one example of the disclosure. The techniques of FIG. 5 may be carried out by one more structural units of video encoder 20.

As shown in FIG. 5, video encoder 20 may be configured to encode video data (500), generate an indication that indicates whether any pictures in the encoded video data contain frame-packed stereoscopic 3D video data (502), and signal the indication in an encoded video bitstream (504).

In one example of the disclosure, the indication comprises a flag. The flag value equal to 0 indicates that all pictures in the encoded video data do not contain frame-packed stereoscopic 3D video data and the encoded video data includes no frame packing arrangement (FPA) supplemental enhancement information (SEI) messages, and the flag value equal to 1 indicates that there may be one or more pictures in the encoded video data that contain frame-packed stereoscopic 3D video data and the encoded video data includes one or more FPA SEI messages.

In another example of the disclosure, the indication is signaled in at least one of a video parameter set (VPS) and a sequence parameter set (SPS). In another example of the disclosure the indication is signaled in a sample entry of video file format information. In another example of the disclosure, the indication is signaled in one of a sample description, a session description protocol (SDP) file, and a media presentation description (MPD).

In another example of the disclosure, the indication is a parameter in an RTP payload. In one example, the indication is a parameter that further indicates a capability requirement of a receiver implementation. In another example, the indication is signaled in at least one of a profile syntax, a tier syntax, and a level syntax.

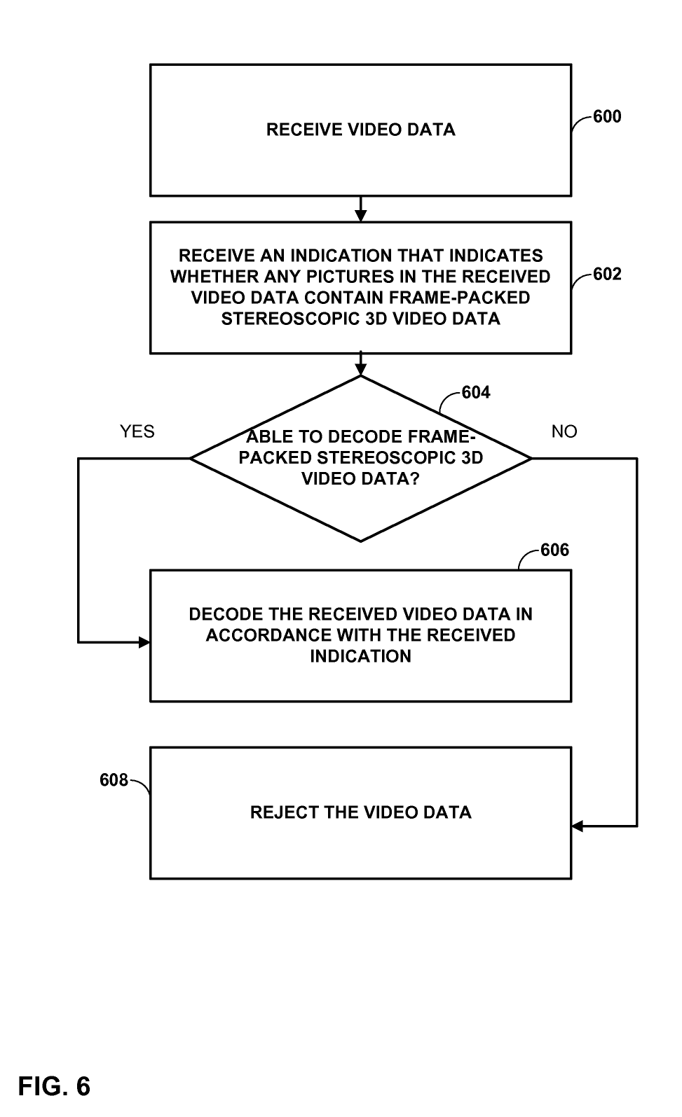

FIG. 6 is a flowchart illustrating an example video decoding method according to one example of the disclosure. The techniques of FIG. 6 may be carried out by one more structural units of video decoder 30.

As shown in FIG. 6, video decoder 30 may be configured to receive video data (600), and receive an indication that indicates whether any pictures in the received video data contain frame-packed stereoscopic 3D video data (602). If video decoder 30 is not able to decode frame-packed stereoscopic 3D video data (604), video decoder 30 is further configured to reject the video data (608). If video decoder 30 is able to decode frame-packed stereoscopic 3D video data, video decoder 30 is further configured to decode the received video data in accordance with the received indication (606). That is, video decoder 30 will decode the video data using frame-packing techniques (e.g., the techniques discussed above with reference to FIG. 2) if the indication indicates that the video data is frame-packed stereoscopic 3D video data, and video decoder 30 will decode the video data using other video decoding techniques if the indication indicates that the video data is not frame-packed stereoscopic 3D video data. Other video decoding techniques may include any video decoding techniques, including HEVC video decoding techniques, that do not include frame-packed stereoscopic 3D video decoding techniques. In some instances, video decoder 30 may reject video data that is indicated as being frame-packed stereoscopic 3D video data.

In one example of the disclosure, the indication comprises a flag. The flag value equal to 0 indicates that all pictures in the received video data do not contain frame-packed stereoscopic 3D video data and the received video data includes no frame packing arrangement (FPA) supplemental enhancement information (SEI) messages, and the flag value equal to 1 indicates that there may be one or more pictures in the received video data that contain frame-packed stereoscopic 3D video data and the received video data includes one or more FPA SEI messages.

In another example of the disclosure, the indication is received in at least one of a video parameter set and a sequence parameter set. In another example of the disclosure, the indication is received in a sample entry of video file format information. In another example of the disclosure, the indication is received in one of a sample description, a session description protocol (SDP) file, and a media presentation description (MPD).

In another example of the disclosure, the indication is a parameter in an RTP payload. In one example, the indication is a parameter that further indicates a capability requirement of a receiver implementation. In another example, the indication is received in at least one of a profile syntax, a tier syntax, and a level syntax.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for decoding video data, the method comprising:
receiving video data;
receiving an indication that indicates whether any pictures in the received video data contain frame-packed stereoscopic 3D video data; and
decoding the received video data in accordance with the received indication.

2. The method of claim 1, wherein the indication comprises a flag, and wherein the flag value equal to 0 indicates that all pictures in the received video data do not contain frame-packed stereoscopic 3D video data and the received video data includes no frame packing arrangement (FPA) supplemental enhancement information (SEI) messages, and wherein the flag value equal to 1 indicates that there may be one or more pictures in the received video data that contain frame-packed stereoscopic 3D video data and the received video data includes one or more FPA SEI messages.

3. The method of claim 1, wherein the indication indicates that there may be one or more pictures in the received video data that contain frame-packed stereoscopic 3D video data and that the received video data includes one or more frame packing arrangement (FPA) supplemental enhancement information (SEI) messages, and wherein decoding the received video data comprises rejecting the video data based on the received indication.

4. The method of claim 1, further comprising receiving the indication in at least one of a video parameter set and a sequence parameter set.

5. The method of claim 1, further comprising receiving the indication in a sample entry of video file format information.

6. The method of claim 5, further comprising receiving the indication in one of a sample description, a session description protocol (SDP) file, and a media presentation description (MPD).

7. The method of claim 1, wherein the indication is a parameter in an RTP payload.

8. The method of claim 7, wherein the indication is a parameter that further indicates a capability requirement of a receiver implementation.

9. The method of claim 1, further comprising receiving the indication in at least one of a profile syntax, a tier syntax, and a level syntax.

10. A method for encoding video data, the method comprising:
encoding video data;
generating an indication that indicates whether any pictures in the encoded video data contain frame-packed stereoscopic 3D video data; and
signaling the indication in an encoded video bitstream.

11. The method of claim 10, wherein the indication comprises a flag, and wherein the flag value equal to 0 indicates that all pictures in the encoded video data do not contain frame-packed stereoscopic 3D video data and the encoded video data includes no frame packing arrangement (FPA) supplemental enhancement information (SEI) messages, and wherein the flag value equal to 1 indicates that there may be one or more pictures in the encoded video data that contain frame-packed stereoscopic 3D video data and the encoded video data includes one or more FPA SEI messages.

12. The method of claim 10, further comprising signaling the indication in at least one of a video parameter set and a sequence parameter set.

13. The method of claim 10, further comprising signaling the indication in a sample entry of video file format information.

14. The method of claim 13, further comprising signaling the indication in one of a sample description, a session description protocol (SDP) file, and a media presentation description (MPD).

15. The method of claim 10, wherein the indication is a parameter in an RTP payload.

16. The method of claim 15, wherein the indication is a parameter that further indicates a capability requirement of a receiver implementation.

17. The method of claim 10, further comprising signaling the indication in at least one of a profile syntax, a tier syntax, and a level syntax.

18. An apparatus configured to decode video data, the apparatus comprising:
a video decoder configured to:
receive video data;
receive an indication that indicates whether any pictures in the received video data contain frame-packed stereoscopic 3D video data; and
decode the received video data in accordance with the received indication.

19. The apparatus of claim 18, wherein the indication comprises a flag, and wherein the flag value equal to 0 indicates that all pictures in the received video data do not contain frame-packed stereoscopic 3D video data and the received video data includes no frame packing arrangement (FPA) supplemental enhancement information (SEI) messages, and wherein the flag value equal to 1 indicates that there may be one or more pictures in the received video data that contain frame-packed stereoscopic 3D video data and the received video data includes one or more FPA SEI messages.

20. The apparatus of claim 18, wherein the indication indicates that there may be one or more pictures in the received video data that contain frame-packed stereoscopic 3D video data and that the received video data includes one or more frame packing arrangement (FPA) supplemental enhancement information (SEI) messages, and wherein the video decoder is further configured to reject the video data based on the received indication.

21. The apparatus of claim 18, wherein the video decoder is further configured to receive the indication in at least one of a video parameter set and a sequence parameter set.

22. The apparatus of claim 18, wherein the video decoder is further configured to receive the indication in a sample entry of video file format information.

23. The apparatus of claim 22, wherein the video decoder is further configured to receive the indication in one of a sample description, a session description protocol (SDP) file, and a media presentation description (MPD).

24. The apparatus of claim 18, wherein the indication is a parameter in an RTP payload.

25. The apparatus of claim 24, wherein the indication is a parameter that further indicates a capability requirement of a receiver implementation.

26. The apparatus of claim 18, wherein the video decoder is further configured to receive the indication in at least one of a profile syntax, a tier syntax, and a level syntax.

27. An apparatus configured to encode video data, the apparatus comprising:
a video encoder configured to:
encode video data;
generate an indication that indicates whether any pictures in the encoded video data contain frame-packed stereoscopic 3D video data; and
signal the indication in an encoded video bitstream.

28. The apparatus of claim 27, wherein the indication comprises a flag, and wherein the flag value equal to 0 indicates that all pictures in the encoded video data do not contain frame-packed stereoscopic 3D video data and the encoded video data includes no frame packing arrangement (FPA) supplemental enhancement information (SEI) messages, and wherein the flag value equal to 1 indicates that there may be one or more pictures in the encoded video data that contain frame-packed stereoscopic 3D video data and the encoded video data includes one or more FPA SEI messages.

29. The apparatus of claim 27, wherein the video encoder is further configured to signal the indication in at least one of a video parameter set and a sequence parameter set.

30. The apparatus of claim 27, wherein the video encoder is further configured to signal the indication in a sample entry of video file format information.

31. The apparatus of claim 30, wherein the video encoder is further configured to signal the indication in one of a sample description, a session description protocol (SDP) file, and a media presentation description (MPD).

32. The apparatus of claim 27, wherein the indication is a parameter in an RTP payload.

33. The apparatus of claim 32, wherein the indication is a parameter that further indicates a capability requirement of a receiver implementation.

34. The apparatus of claim 27, wherein the video encoder is further configured to signal the indication in at least one of a profile syntax, a tier syntax, and a level syntax.

35. An apparatus configured to decode video data, the apparatus comprising:
means for receiving video data;
means for receiving an indication that indicates whether any pictures in the received video data contain frame-packed stereoscopic 3D video data; and
means for decoding the received video data in accordance with the received indication.

36. An apparatus configured to encode video data, the apparatus comprising:
means for encoding video data;
means for generating an indication that indicates whether any pictures in the encoded video data contain frame-packed stereoscopic 3D video data; and
means for signaling the indication in an encoded video bitstream.

37. A computer-readable storage medium storing instructions that, when executed, cause one or more processors of a device configured to decode video data to:
receive video data;
receive an indication that indicates whether any pictures in the received video data contain frame-packed stereoscopic 3D video data; and
decode the received video data in accordance with the received indication.

38. A computer-readable storage medium storing instructions that, when executed, cause one or more processors of a device configured to encode video data to:
encode video data;
generate an indication that indicates whether any pictures in the encoded video data contain frame-packed stereoscopic 3D video data; and
signal the indication in an encoded video bitstream.
